(19) United States
(12) Patent Application Publication
(10) Pub. No.: US 2019/0339607 A1
(43) Pub. Date: Nov. 7, 2019

(54) DECORATIVE PROJECTION LIGHT ASSEMBLIES, SYSTEMS, AND METHODS

(71) Applicant: Optlaser Technologies Co., LTD

(72) Inventors: Wei Yanping, Shenzhen (CN); Sun Linhong, Shenzhen (CN)

(21) Appl. No.: 16/253,241

(22) Filed: Jan. 22, 2019

Related U.S. Application Data
(63) Continuation-in-part of application No. 15/972,422, filed on May 7, 2018.

(51) Int. Cl. G03B 23/12; G03B 21/20

(52) U.S. Cl. CPC G03B 23/12; G03B 21/2033

(57) ABSTRACT

A projection light assembly is provided which achieves a multi-theme animation effect. The projection light assembly includes a gear holder, a first gear and a second gear operably linked by the gear holder, a motor coupled to one or both of the first gear and second gear, a grating unit holder movably connected to one or both of the first gear and second gear, and a grating unit mounted to the grating unit holder. The grating unit is driven by the motor and moved by the first gear and second gear such that the grating unit moves circumferentially in a fixed radius. At least one laser light source is positioned such that light generated by the laser light source and transmitted in a light path projects through the grating unit. A transmission belt may be coupled to the first gear and the second gear, and the grating unit is driven by the motor and moved by the transmission belt. A projection light assembly may include a slider board a motor coupled to the slider board, an eccentric wheel coupled to the motor, a laser slider disposed in the slider board, and a grating unit disposed in the laser slider, wherein the grating unit is driven by the motor and moved by the eccentric wheel.

### CROSS-REFERENCE TO RELATED APPLICATION

This application is a continuation-in-part of and claims priority to U.S. patent application Ser. No. 15/972,422, filed May 7, 2018, which is hereby incorporated by reference in its entirety.

### FIELD OF THE DISCLOSURE

The following disclosure relates to decorative projection light assemblies, systems, and methods, including decorative lights and multi-theme animation laser projection light assemblies.

### BACKGROUND

Decorative lights are increasingly popular and are often used to decorate indoor and outdoor spaces of homes and stores. They are used most around holiday times but can be used all year round to create special effects and designs. Today, there are various kinds of decorative lights available, including laser lights, string lights, and character lights.

Currently available decorative lighting devices can create a wide variety of patterns and some can achieve the effect of a moving pattern. However, existing lamps can only achieve the effect of the pattern; they cannot provide an animation effect. Accordingly, there is a need for a decorative projection light that achieve an animation effect. There is also a need for a decorative projection light that can reliably show animation. Finally, there is a need for a decorative projection light that can provide a compact structure and keep manufacturing costs low while achieving multi-theme animation effects.

### SUMMARY

The present disclosure, in its many embodiments, alleviates to a great extent the disadvantages of known decorative projection lights by providing a new projection light assembly that can achieve an animation effect. Disclosed embodiments project the light of the laser transmission through one or more grating groups. A motor controls the rotation of the grating groups so it passes gradually, in turn, through the light path generated by the laser light source. In this way, the theme design gradually changes, creating animation effects. By adjusting the positions of different grating groups using a button or other mechanism the animation themes can be changed. Disclosed projection lights have application in the indoor and outdoor family landscape decoration and holiday lighting market. Disclosed embodiments represent further innovations and transformations of existing laser lamps. Through the design of the program and structure, the output effect of the multi theme animation is achieved through the motor, the laser and the grating groups.

Exemplary embodiments of a projection light assembly comprise a main mount board, at least one laser light source coupled to the main mount board, a grating group platform rotatably coupled to the main mount board, at least one grating group mounted to the grating group platform, a motor coupled to the main mount board and/or the grating group platform, and a motherboard in communication with the laser light source, the grating group, and the motor. Light is generated by the laser light source and transmitted in a light path which projects through the grating group, and the motor drives the grating group to rotate through the light path.

In exemplary embodiments, the at least one grating group contains multiple frames, and each frame may contain a different animation pattern representing a different action or change in theme. In exemplary embodiments, the motor drives the grating group to rotate back and forth such that the frames sequentially enter and exit the light path. The projection light assembly may further comprise a switch to reset the grating group platform and return the grating group platform to its initial position. In exemplary embodiments, the main mount board has at least one stop pile and the grating group platform has at least one stop piece, and when rotation of the grating group platform causes the stop piece to contact the stop pile, the grating group platform resets and returns to its initial position.

In exemplary embodiments, the at least one grating group is in the form of an arc. In other embodiments, the at least one grating group is in the form of a helix. The at least one grating group may comprise at least two different grating groups, and each grating group corresponds to a different theme. The motor may drive the grating groups to rotate such that the different grating groups enter and exit the light path so the different themes are displayed. In exemplary embodiments, two or more grating groups are configured in a hexagonal arrangement or a circular arrangement, and the motor has an axis located in the middle of the arrangement of grating groups.

The grating groups may be manually replaceable. In exemplary embodiments, the at least one grating group is not moved, and the laser source scans the grating group to create an animation effect. In exemplary embodiments, there are at least two different themes, each theme having one or more frames, and the frames are arranged in a helix. The grating group platform may have a vertical screw structure, and the motor may drive the screw structure to move up and down to rotate the different frames such that the different frames enter and exit the light path so the different themes are displayed.

Exemplary methods of projecting multi-theme animation comprise providing at least one grating group containing multiple frames where each frame contains a different pattern, generating light from a laser light source such that the light is transmitted in a light path projecting through the at least one grating group, and driving the grating group to rotate such that the frames sequentially enter and exit the light path. In exemplary embodiments, the at least one grating group comprises at least two different grating groups, each grating group corresponding to a different theme. When the different grating groups enter and exit the light path the different themes are displayed. Exemplary methods may further comprise resetting the at least one grating group and returning the at least one grating group to its initial position.

Exemplary methods comprise providing at least two different grating groups, each grating group corresponding to a different theme, and arranging the grating groups in a hexagonal arrangement or a circular arrangement. Exemplary methods comprise providing at least two different themes, each theme having one or more frames, and arranging the frames in a helix. A vertical screw structure may be provided. Exemplary methods include driving the screw structure so it moves up and down to rotate the different frames such that the different frames enter and exit the light path so the different themes are displayed.

Exemplary methods of manufacturing a projection light assembly comprise coupling at least one laser light source to a main mount board, rotatably coupling a grating group platform to the main mount board, mounting at least one grating group to the grating group platform such that light generated by the laser light source and transmitted in a light path projects through the grating group, coupling a motor to the main mount board and/or the grating group platform, the motor driving the grating group to rotate through the light path, and communicatively connecting a motherboard with the laser light source, the grating group, and the motor. Exemplary methods may further comprise connecting at least one stop pile to the main mount board and at least one stop piece to the grating group platform. When rotation of the grating group platform causes the stop piece to contact the stop pile, the grating group platform resets and returns to its initial position. Exemplary methods may further comprise providing a switch to reset the grating group platform and return the grating group platform to its initial position.

In exemplary embodiments, a projection light assembly comprises a gear holder, a first gear and a second gear operably linked by the gear holder, a motor coupled to one or both of the first gear and second gear, a grating unit holder movably connected to one or both of the first gear and second gear, a grating unit disposed in the grating unit holder, and at least one laser light source. The grating unit is driven by the motor and moved by the first gear and second gear such that the grating unit moves circumferentially in a fixed radius. The laser light source is positioned such that light generated by the laser light source and transmitted in a light path projects through the grating unit.

In exemplary embodiments, the first gear and the second gear have substantially the same diameter. When the grating unit is moved, the light path projected through the grating unit creates an animation effect. The grating unit may contain multiple frames arranged in a circle. In exemplary embodiments, each frame contains a different animation pattern representing a different action or change in theme. In exemplary embodiments, each frame is arranged horizontally with respect to the center of the circle. The first gear may be a passive gear and the second gear may be a drive gear. A third gear operably connected to the first and second gear may be provided, and the third gear may be a transmission gear. In exemplary embodiments, the grating unit is manually replaceable.

An exemplary projection light assembly comprises a first wheel and a second wheel, a transmission belt coupled to the first wheel and the second wheel, a motor coupled to one or both of the first wheel and second wheel, a grating unit coupled to the transmission belt, and at least one laser light source. The grating unit is driven by the motor and moved by the transmission belt. The laser light source is positioned such that light generated by the laser light source and transmitted in a light path projects through the grating unit. The grating unit may move circumferentially in a fixed radius or in a straight line. When the grating unit is moved, the light path projected through the grating unit creates an animation effect. In exemplary embodiments, the grating unit contains multiple frames arranged in a circle. In exemplary embodiments, the projection light assembly further comprises a gear holder and a grating unit holder movably connected to one or both of the first wheel and second wheel. The grating unit may be coupled to the transmission belt via the grating unit holder and one or both of the first wheel and second wheel, and the grating unit moves circumferentially in a fixed radius.

Exemplary embodiments of a projection light assembly comprise a slider board, a motor coupled to the slider board, an eccentric wheel coupled to the motor, a laser slider disposed in the slider board, a grating unit disposed in the laser slider, and at least one laser light source operably connected to the slider board. The grating unit is driven by the motor and moved by the eccentric wheel. The laser light source is operably connected to the slider board such that light generated by the laser light source and transmitted in a light path projects through the grating unit. In exemplary embodiments, the grating unit is in a two-dimensional plane. When the grating unit is moved, the light path projected through the grating unit creates an animation effect. In exemplary embodiments, the grating unit contains multiple frames arranged in a circle.

Accordingly, it is seen that decorative projection light assemblies, systems, and methods are provided which create animation effects. Disclosed embodiments advantageously provide a compact structure and keep manufacturing costs relatively low while achieving multi-theme animation effects. These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a perspective view of an exemplary embodiment of a projection light assembly in accordance with the present disclosure;

FIG. 2 is a perspective and detail view of an exemplary embodiment of a projection light assembly in accordance with the present disclosure;

FIG. 3 is an exploded view of an exemplary embodiment of a projection light assembly in accordance with the present disclosure;

FIG. 4 is a perspective view of an exemplary embodiment of a projection light assembly in accordance with the present disclosure;

FIG. 5 is a perspective view of an exemplary embodiment of a projection light assembly in accordance with the present disclosure;

FIG. 6 is a perspective view of an exemplary embodiment of a projection light assembly in accordance with the present disclosure;

FIG. 7 is a perspective view of an exemplary embodiment of a projection light assembly in accordance with the present disclosure;

FIG. 8A is a perspective view of an exemplary embodiment of a projection light assembly in accordance with the present disclosure;

FIG. 8B is a perspective and detail view of the projection light assembly of FIG. 8A;

FIG. 8C is an exploded view of the projection light assembly of FIG. 8A;

FIG. 9 is a perspective view of an exemplary embodiment of a projection light assembly in accordance with the present disclosure;

FIG. 10 is a perspective view of an exemplary embodiment of a projection light assembly in accordance with the present disclosure;

FIG. 11 is a perspective view of an exemplary embodiment of a projection light assembly in accordance with the present disclosure;

FIG. 12 is a perspective view of an exemplary helical arrangement and vertical screw structure in accordance with the present disclosure;

FIG. 13 is a perspective view of an exemplary embodiment of a projection light assembly in accordance with the present disclosure;

FIG. 14 is a perspective view of an exemplary embodiment of a projection light assembly in accordance with the present disclosure;

FIG. 15 is a perspective view of an exemplary embodiment of a system and method of projecting multi-theme animation in accordance with the present disclosure;

FIG. 16 is a perspective view of an exemplary embodiment of a system and method of projecting multi-theme animation in accordance with the present disclosure;

FIG. 17 is a perspective view of an exemplary embodiment of a system and method of projecting multi-theme animation in accordance with the present disclosure;

FIG. 18 is a perspective view of an exemplary embodiment of a projection light assembly in accordance with the present disclosure;

FIG. 19 is a perspective view of an exemplary embodiment of a projection light assembly in accordance with the present disclosure;

FIG. 20 is a perspective view of an exemplary embodiment of a system and method of projecting multi-theme animation in accordance with the present disclosure;

FIG. 21A is a rear perspective view of an exemplary embodiment of a projection light assembly in accordance with the present disclosure;

FIG. 21B is front perspective view of the perspective light assembly of FIG. 21A;

FIG. 22 is a schematic of an exemplary embodiment of a system and method of projecting multi-theme animation in accordance with the present disclosure;

FIG. 23A is a rear perspective view of an exemplary embodiment of a projection light assembly in accordance with the present disclosure;

FIG. 23B is front perspective view of the perspective light assembly of FIG. 21A;

FIG. 24 is a rear perspective view of an exemplary embodiment of a projection light assembly in accordance with the present disclosure;

FIG. 25A is a rear perspective view of an exemplary embodiment of a projection light assembly in accordance with the present disclosure;

FIG. 25B is a rear perspective view of components of the projection light assembly of FIG. 25A; and

FIG. 25C is an exploded view of the projection light assembly of FIG. 25A.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

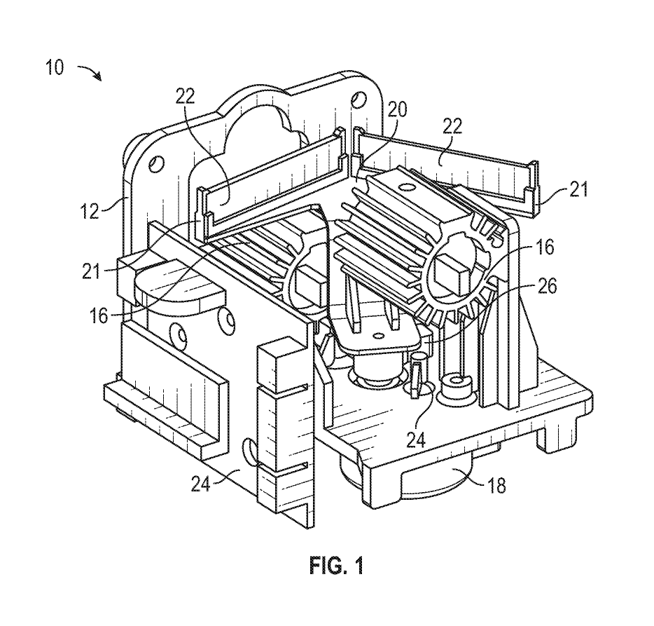

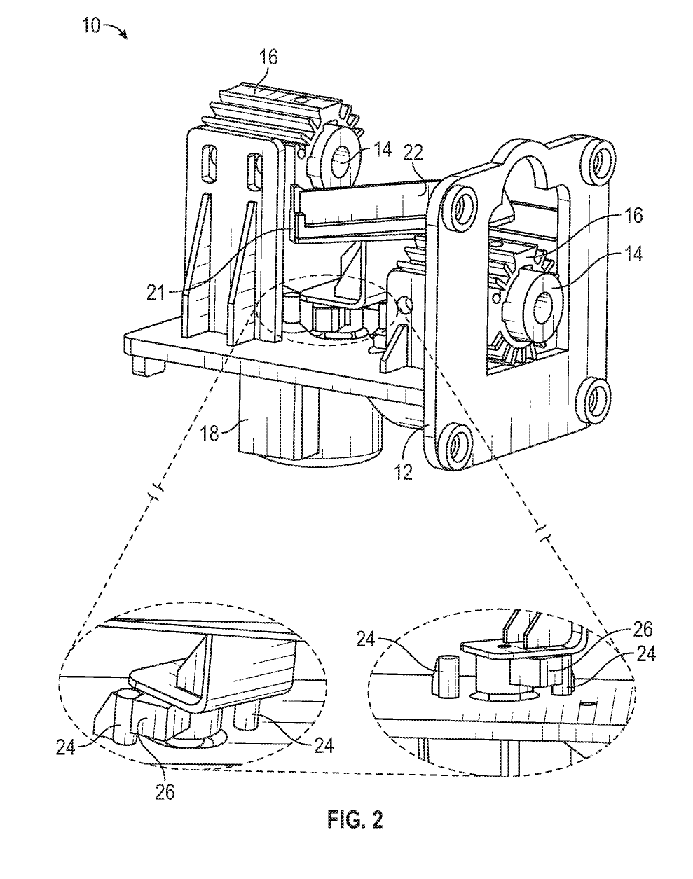

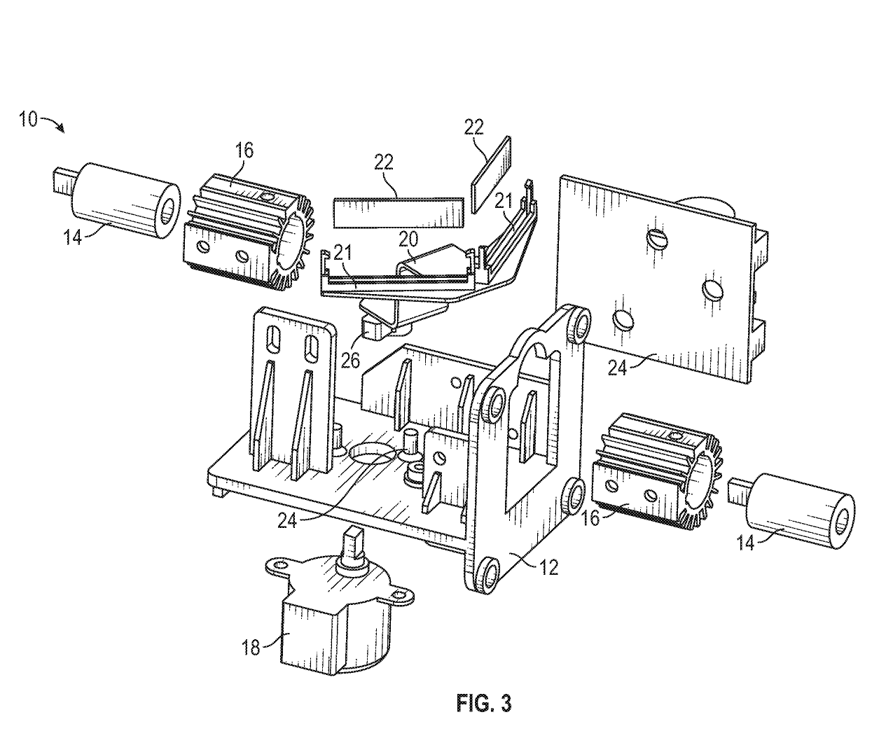

FIGS. 1-4 illustrate exemplary embodiments of a projection light assembly. Projection light assembly 10 comprises a main mount board 12 which has a number of components attached or coupled to it. At least one laser light source 14 is coupled to the main mount board 12. Any number of laser light sources could be used in a variety of colors including but not limited to red, green, blue, and white. Exemplary embodiments include a laser module mount 16 to facilitate connection of the laser light source 14. More particularly, laser light source 14 is connected to the laser module mount 16, which, in turn, is coupled to the main mount board 12, thereby mounting the laser light source 14.

One or more motors 18 may be provided and attached to the main mount board 12. In exemplary embodiments, motor 18 is located below the main mount board 12 and may be connected to a bottom surface of the main mount board and/or partially penetrating through an aperture in the bottom surface of the main mount board. It should be noted, however, that the motor 18 could be in various locations depending on the application and desired movement of the other components of the projection light assembly 10. A motherboard (or PCB or PCBA board) 24 is provided and is in communication with the laser light source 14, the motor 18, and one or more grating groups 22.

In exemplary embodiments, a grating group platform or disk 20 is coupled to the main mount board 12, and at least one grating group 22 mounted to the grating group platform 20. The grating group 22 and grating group platform 20 are configured and located so the grating group 22 is generally in the path of light projected by the laser light source 14. More particularly, when light is generated by the laser light source 14, it is transmitted in a light path 15 that projects through the grating group 22. A grating group mount 21 may be attached to or integrally formed with the grating group platform 20 and the grating group or groups attached to the grating group disk in various configurations described in more detail herein.

In exemplary embodiments, the grating group platform 20 is rotatably coupled to the main mount board 12 so the grating group 22 can be rotated back and forth in the light path 15. A stop pile 24 may be formed on or attached to a surface of the main mount board 12, a corresponding stop piece 26 formed on or attached to the grating group platform 20. As described in more detail herein, contact between the stop pile 24 and stop piece 26 stops rotation of the grating group platform 20 and grating group 22 and may reset the movement path. As described in more detail herein, a switch may be provided to reset the grating group platform 20 and return it to its initial position.

In exemplary embodiments, the grating group 22 is in the form of a long straight or curved strip and contains a number of different patterns. As best seen in FIGS. 5 and 7, a grating group 22 may be comprised of multiple frames 28, where each frame is an individual pattern of a theme or story and together the frames 28 of a grating group 22 make up a whole theme or story. The concept is similar to that of paper animation frames or reels of film. As discussed in more detail herein, in various embodiments, the grating group or groups may be in the form of an arc or helix.

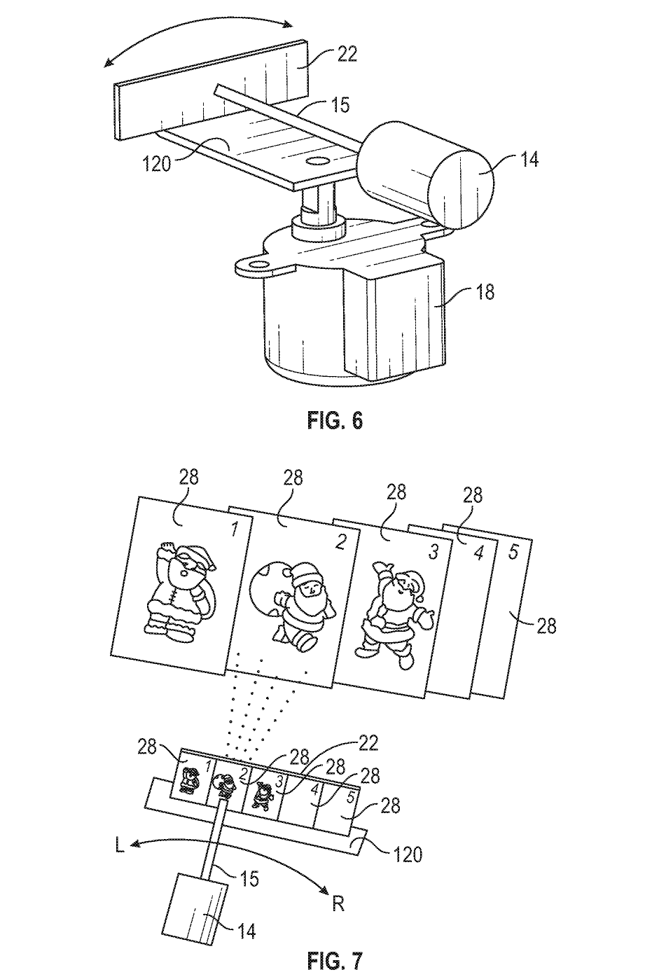

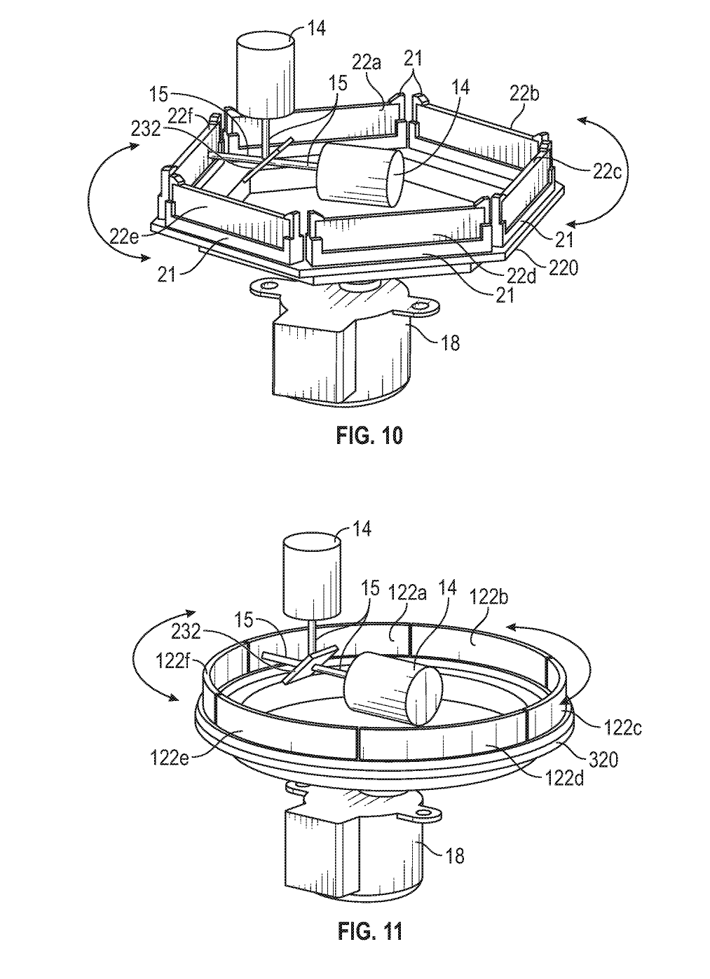

Turning to FIGS. 6-12, exemplary embodiments of projection light assembly having different numbers of grating groups will be described. An exemplary projection light assembly which has one grating group 22 is illustrated in FIGS. 6 and 7. The laser light source 14 projects and transmits a light path 15 through the grating group 22 as the motor drives the grating group platform 120 to rotate back and forth to display the different frames 28 of the grating group 22. The grating group platform 120 has a substantially flat surface suitable for mounting the grating group 22. In exemplary embodiments, grating group platform 120 is square or rectangular and has grating group 22 mounted at a distal edge opposite the location of the laser light source 14. The grating group 22 could sit directly on the grating group platform 120 or could be mounted in a grating group mount 21. In exemplary embodiments, the grating groups are manually replaceable.

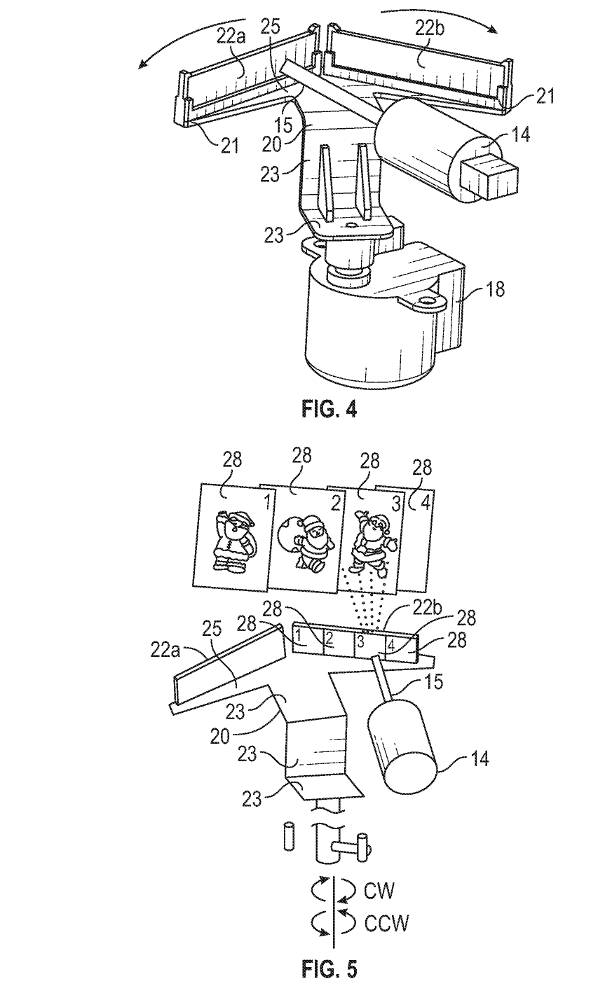

As best seen in FIGS. 4 and 5, two different grating groups 22 may be provided where each grating group corresponds to a different theme. Grating group platform 21 designed to support two grating groups 22a, 22b. In exemplary embodiments, grating group platform 20 comprises stepped sections 23 and a triangular shaped flat section 25 with space to mount two grating groups 22a, 22b. It should be noted that the grating group platform, and the flat section in particular, could take different forms and shapes such as a semi-circle, a T-shape, or any other shape suitable for mounting two grating groups. The grating groups 22 could sit directly on the flat section 25 of the grating group platform 20 or could be mounted in grating group mounts 21. The motor 18 drives the grating groups 22 so they rotate. More particularly, the grating groups 22 rotate so that the two different grating groups 22a, 22b enter and exit the light path 15, thereby displaying in turn first the theme contained in the frames of first grating group 22a and then the theme contained in frames of the second grating group 22b. This configuration can be used with up to five grating groups.

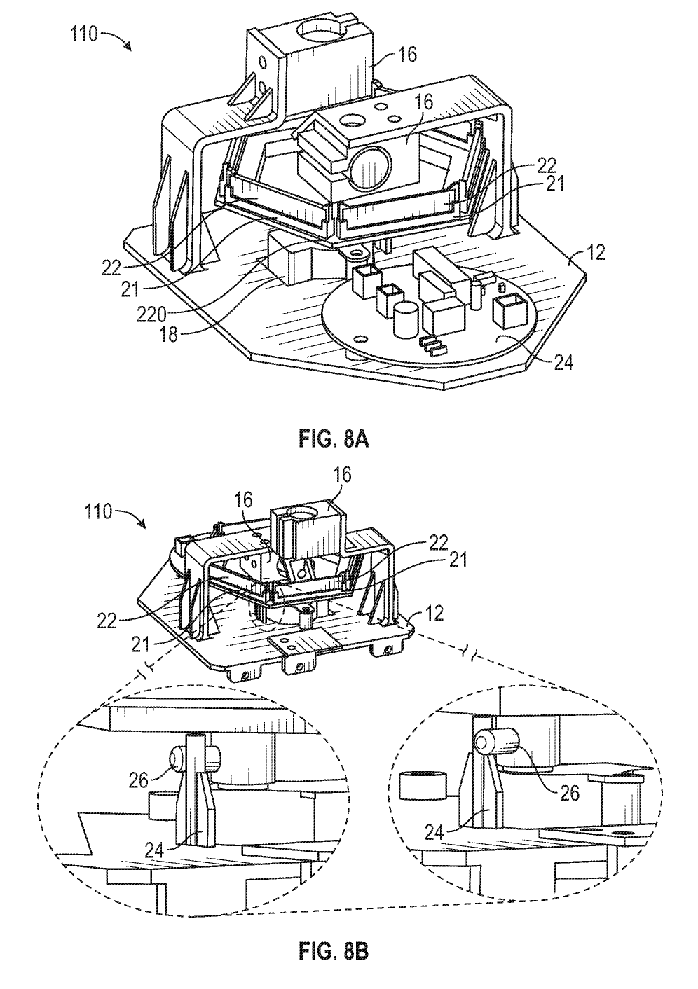

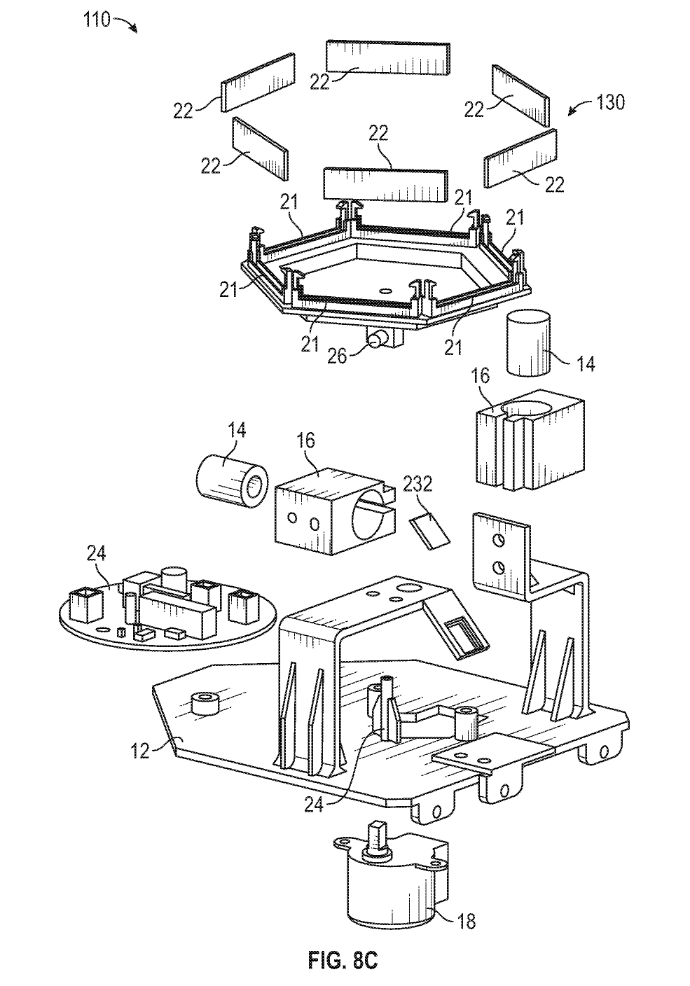

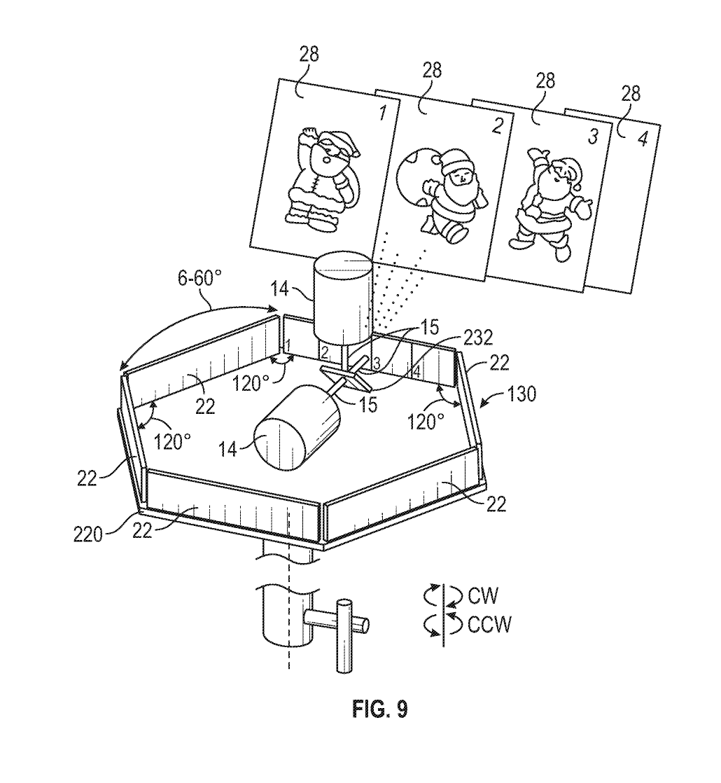

In exemplary embodiments, two or more different grating groups are provided and configured in a hexagonal or circular arrangement. As shown in FIGS. 8A-11, exemplary projection light assemblies 110 have six different grating groups 22, each corresponding to a different theme or story. In such embodiments, the number of grating groups and frames is large enough to be completely surrounded. Thus, the optimal configuration for six grating groups is either a hexagonal arrangement 130 or a circular arrangement 132 with the laser light source 14 is located in the center surrounded by the six grating groups 22a-22f, 122a-122f. As best seen in FIG. 9, the angle between each two grating groups is 120 degrees, so the assembly forms six grating groups 22a-22f situated on the edges of the hexagonal grating group disk 220.

An exemplary circular arrangement can be seen in FIG. 11, wherein six curved grating groups 122a-122f surround the laser light source 14. The axis of the motor 18 is located in the middle of the circular grating group disk 320, so the motor can drive the grating group platform or disk 320 so the laser light path 15 passes through the arrangement of grating groups 122a-122f. As best seen in FIGS. 9-11, exemplary embodiments include a reflector 232 coupled to motor 18. Reflector 232 enables light paths 15 from two different laser light sources 14 to be transmitted from the laser light sources 14 through the grating groups 22a-22f, 122a-122f.

Turning to FIG. 12, exemplary embodiments of projection light assemblies having seven or more themes will now be described. When the theme pattern needs more than six different themes, using grating groups may not be feasible. In these instances, the structure of the projection light assembly is changed so the frames are not placed on a plane. Rather, the the grating group platform 420 has a vertical screw structure 413. Multiple themes or stories, where each may include one or more frames, are arranged in a helix 415 encircling the main mount board. In other words, the grating group itself is made into helical or spiral structure. The motor 18 drives the screw structure 413 to move up and down to rotate the different frames of the helix so they enter and exit the light path 15 so the different themes are displayed. The screw structure 413 can be made to rotate and move up and down at the same time by motor rotation, thereby achieving the theme effect by control of the motor 18. In exemplary embodiments, a second laser light source is added, and one laser is used for the background, the other used for the theme. This prevents the pattern from becoming monotonous.

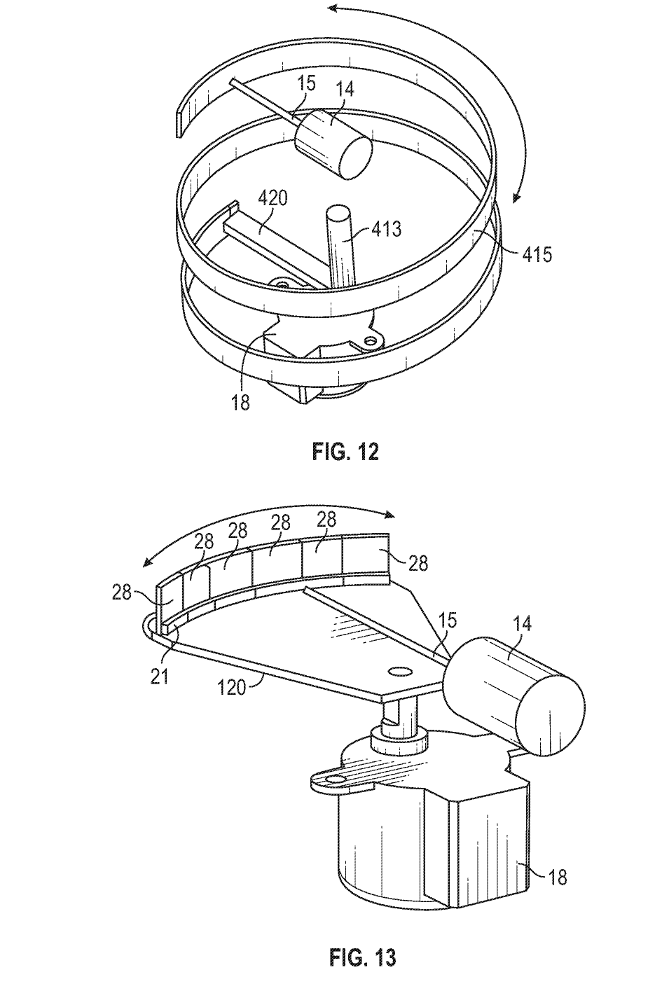

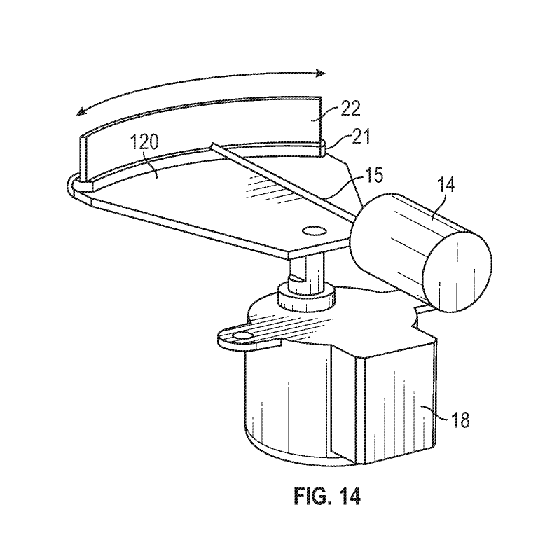

FIGS. 13-14 illustrate exemplary embodiments in which a grating group 22, individual grating units or frames 28 are arranged in a semi-circle. As best seen in FIG. 13, single grating units or frames 28 may be composed of grating groups 22 where the grating group structure is approximately a circular arc. In FIG. 14, it can be seen that the single grating group 22 is made of a circular arc. The center of the circle is located at the point of emission of the laser light source 14. It is should be noted that the closer the grating structure is with the circle, the lower the deformability.

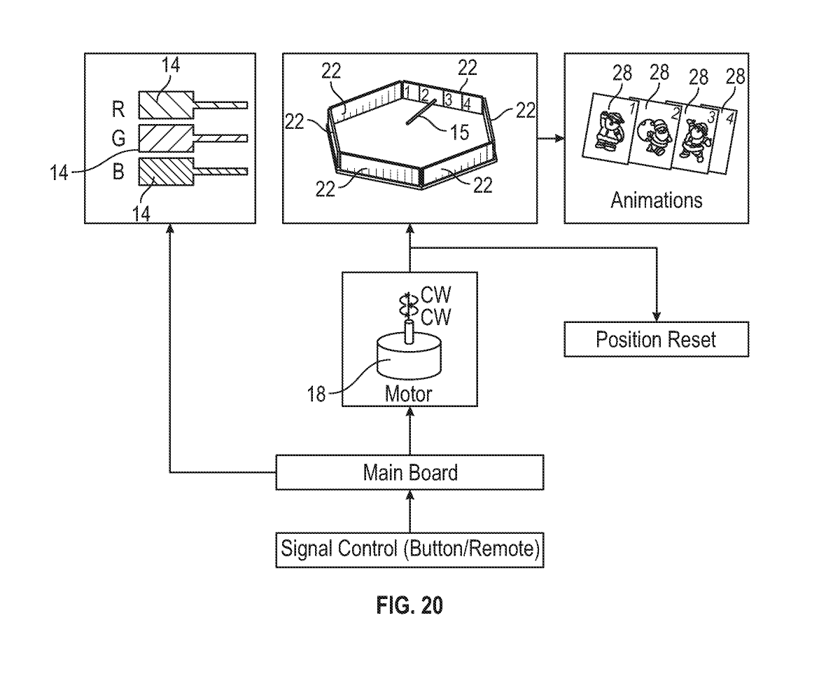

In operation, exemplary projection light systems and methods create multi-theme animation effects by the following general steps, illustrated in FIG. 20. They provide at least one grating group 22 which contains multiple frames 28, and each frame contains a different pattern. As illustrated in FIGS. 5, 7, 9, and 15. light is generated from a laser light source 14 and is transmitted in a light path 15 projecting through the grating group 22. The grating group 22 is driven to rotate so the frames 28 sequentially enter and exit the light path 15. More particularly, a motor 18 drives the grating group or groups 22 to rotate back and forth, so that the light from the laser light source 14 is swept from the first frame to the N frame, and then the N frame is swept to the first frame. This cycle can display different patterns of a theme and create animation effect. In exemplary embodiments, the grating group or groups 22 are mounted on a grating group platform or disk 20, and the motor 18 drives the platform or disk 20 to rotate through the light path 15.

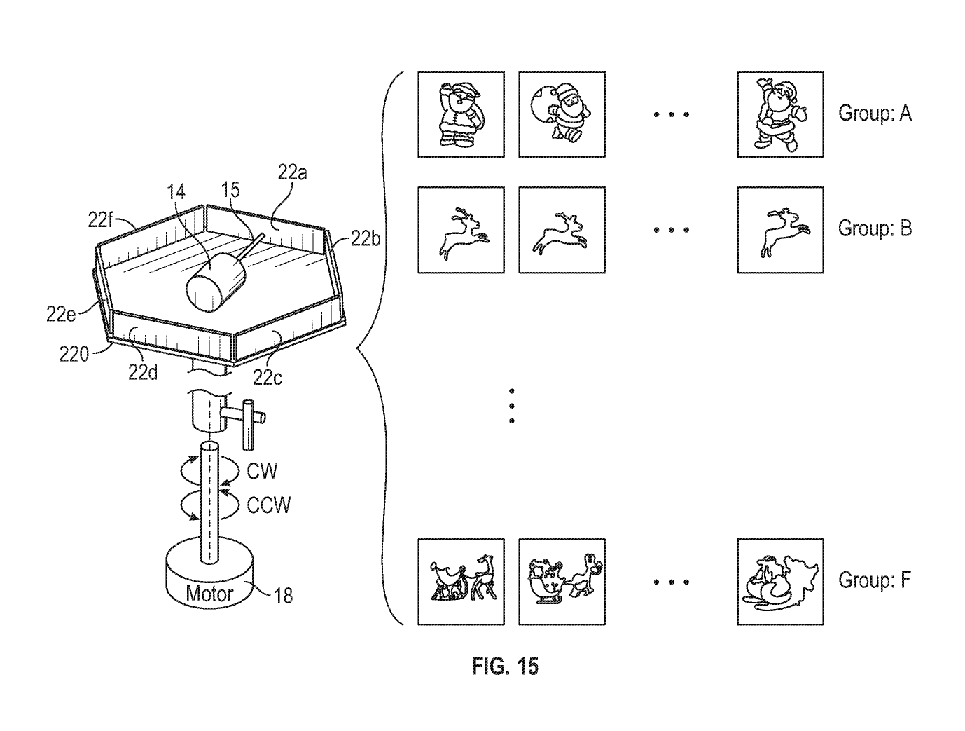

As discussed above, the number of grating groups could range from one to almost any number. Likewise, the number of frames could vary considerably. The number of grating groups or frames needed might depend on the length or complexity of the themes or stories being conveyed. As the number of topics increases, the structure design needs to make corresponding improvements. As best seen in FIG. 15, exemplary methods of creating multi-theme animation effects using multiple grating groups 22a-22f include arranging the grating groups in a hexagonal arrangement or a circular arrangement and projecting the light path 15 through the grating groups 22a-22f sequentially through groups or themes A-F. As discussed above, when the theme or story requires seven or more grating groups 22, they may be arranged in a spiral or helix configuration 415 and a vertical screw structure 413 is provided. The screw structure 413 is driven to move up and down to rotate the different frames of the helix 415 so they enter and exit the light path 15 so the different themes are displayed.

In exemplary embodiments, methods of resetting a projection light assembly and switching themes or stories are provided. These could include resetting and starting the same theme again or switching to a new theme and starting the new theme. When the animation lights are activated and switched to the theme of animation, a reset action may be required. An exemplary reset method comprises resetting at least one grating group 22 and returning it to its initial position. The method may utilize a stop mechanism, as described above, in which there is a stop pile 24 on a surface of the main mount board 12 and a corresponding stop piece 26 on the grating group platform 20. When the stop piece 26 is contacted by the stop pile 24, they stop rotation of grating group platform 20 and the rotary mechanism returns to the initial position to complete the reset. Exemplary mechanical stop reset methods can also use a Holzer switch or a position switch to transmit the reset position to a single chip computer on the motherboard 24 to achieve the same purpose. When reset, the main circuit control motor may rotate against the clock. These methods can also be used to achieve a switch from one theme or story to another theme or story.

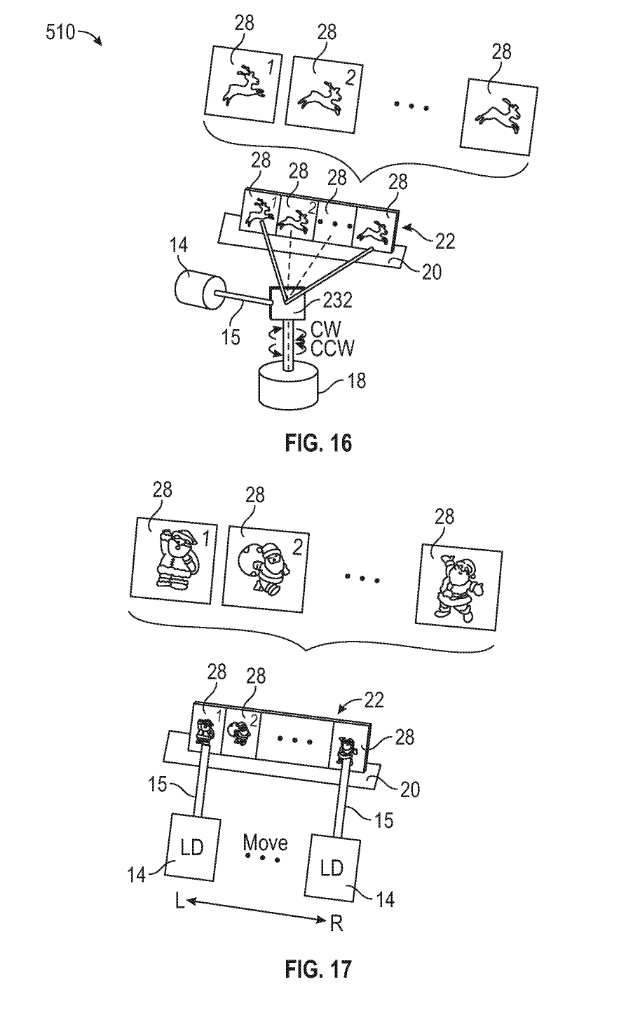

Turning to FIGS. 16-19, exemplary methods of providing multi-theme animation effects without moving grating groups will now be described. As shown in FIG. 16, projection light assembly 510 includes a reflector 232 coupled to motor 18. The laser light source 14 and grating group 22 are fixed in position and are not moved. Rather, the reflector 232 is shifted or its angle changed so the light path 15 transmitted from the laser light source 14 scans the grating group 22. In another method, illustrated in FIG. 17, the laser light source module 14 itself could be shifted or the angle of the module rotated so the light path 15 transmitted from the laser light source 14 scans the grating group 22.

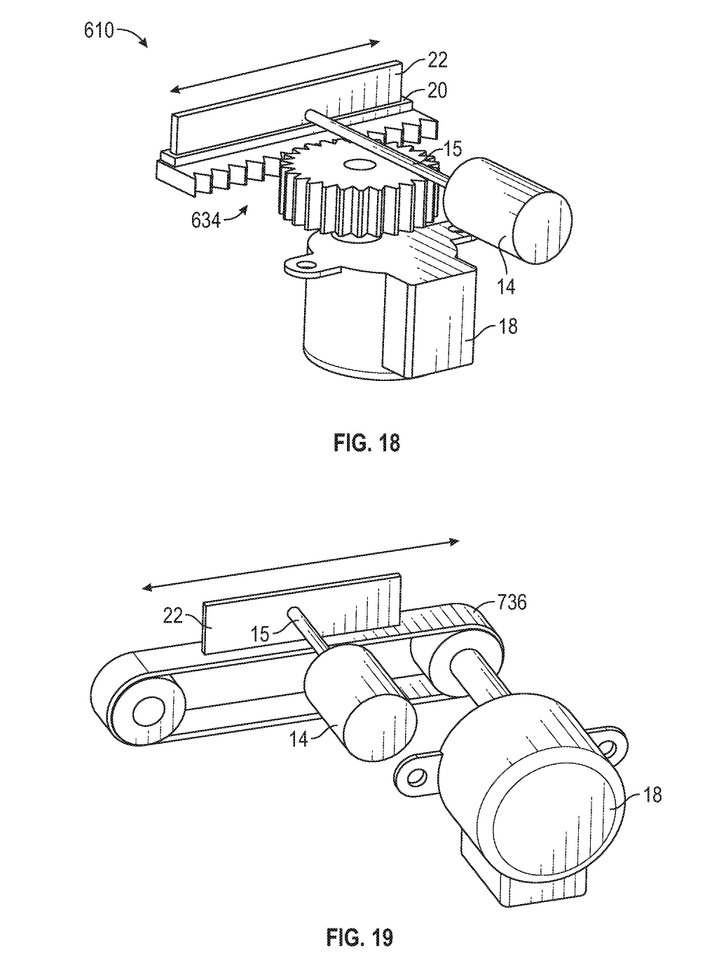

FIG. 18 illustrates a projection light assembly 610 in which motor 18 drives a rack or belt 634 to make the grating group 22 move in a straight line. Due to the limited size of the light body, this method does not support the long size grating group and would be used for fewer grating groups only, and typically a single grating group. In this method, the grating group would not be changed. In another embodiment of a projection light assembly 710, shown in FIG. 19, motor 18 drives a rack to move back and forth so that the laser light source 14 can evenly sweep all the patterns of the grating group 22. The rack can also be replaced by a belt 736 and the motor 18 would drive one of the wheels to turn back and forth. This method also would be used for fewer grating groups only, and typically a single grating group.

Exemplary methods of manufacturing projection lighting assemblies having multi-theme animation capability are also provided. A method of manufacturing a projection light assembly 10, 110, 510, 610, 710 comprises coupling a laser light source 14 to a main mount board 12. A grating group platform 20 is also coupled to the main mount board 12. In exemplary embodiments, the grating group platform 20 is connected so it can rotate relative to the main mount board 12. One or more grating groups 22 are mounted to the grating group platform 20, either directly or via one or more grating group mounts 21. The grating groups 22 are positioned so a light path 15 transmitted by the laser light source 14 projects through them. A motor 18 is coupled to the main mount board 12 and/or to the grating group platform 20 so it can drive the grating group or groups 22 to rotate through the light path 15.

A motherboard 24 is connected so it can electronically communicate with one or more of the other components of the projection light assembly including, but not limited to, the laser light source 14, the grating group platform 20, and the motor 18. At least one stop pile 24 is connected to or integrally formed with the main mount board 12. At least one corresponding one stop piece 26 is connected to or integrally formed with the grating group platform 20. The stop pile 24 and stop piece are position so that rotation of the grating group platform 20 causes the stop piece 26 to contact the stop pile 24. When this occurs, the grating group platform 20 resets and returns to its initial position.

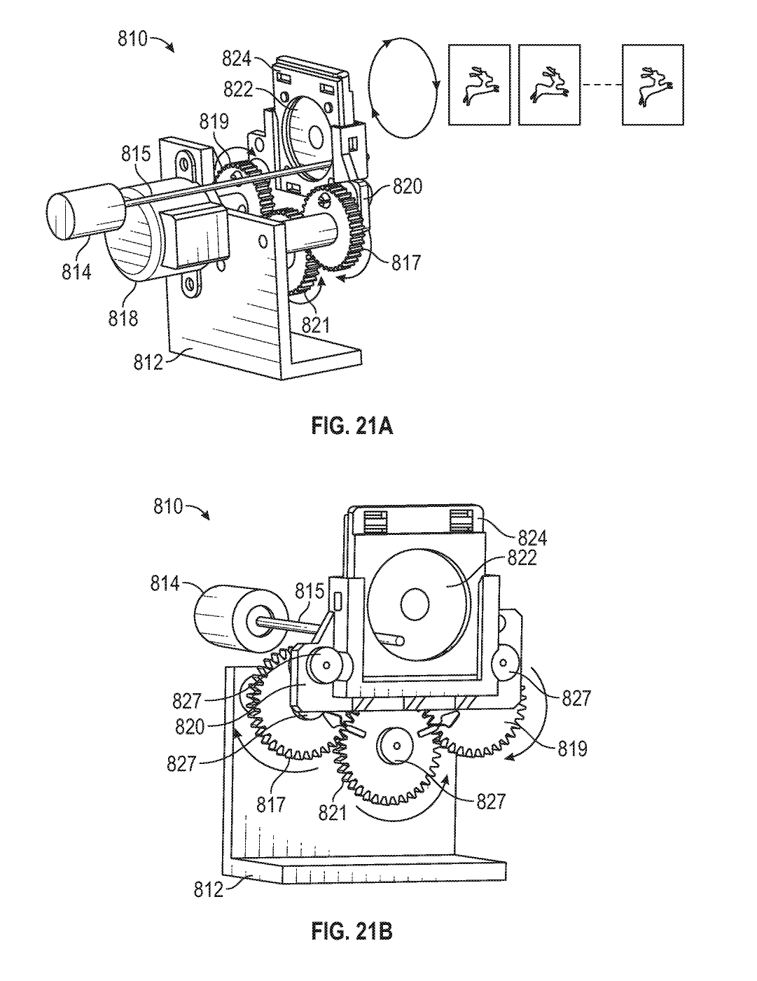

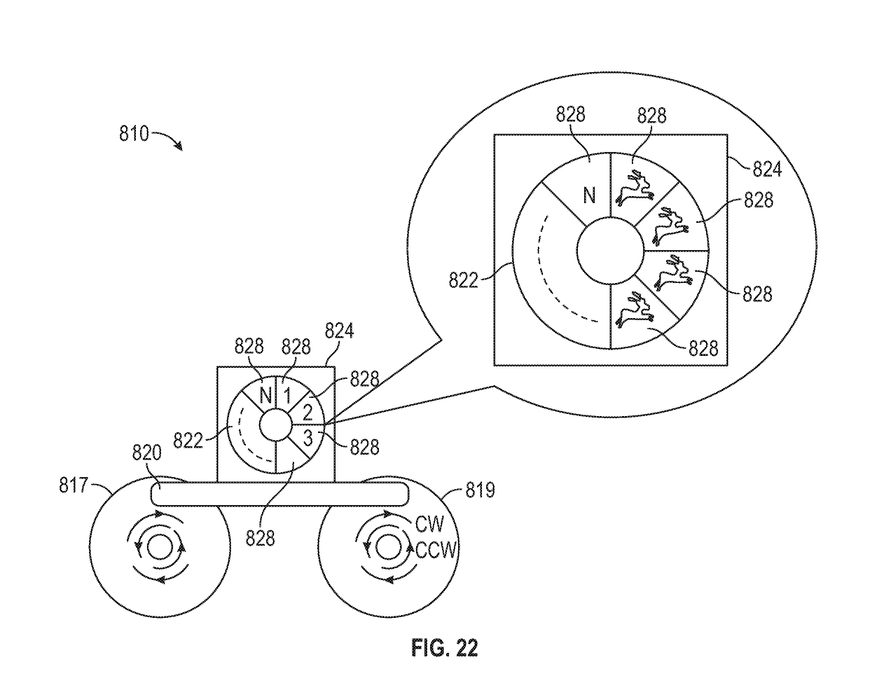

Referring to FIGS. 21A, 21B and 22, an exemplary embodiment of a gear-driven projection lighting assembly will now be described. Projection lighting assembly 810 utilizes two or more gears linked by a gear holder linkage to move the grating unit across a laser light path and generate animation. More particularly, projection lighting assembly 810 comprises a gear holder 812 which mounts first and second gears 817, 819. In exemplary embodiments, the first gear 817 and second gear 819 are of about the same diameter. The first gear 817 typically would be a passive gear and the second gear 819 would be a drive gear. A third gear 821 could be provided as a transmission gear. A grating unit holder 820 is connected to one or both of the first gear 817 and second gear 819 and operably links the gears. Pins 827 may be used to attach the grating unit holder 820 to the gears 817, 819. In exemplary embodiments, a grating unit 822 is located in the grating unit holder 820, and a buckle 824 may be provided to secure the grating unit 822 to the grating unit holder 820.

One or more motors 818 may be provided and attached to the gear holder 812 and operably connected to one or both of the gears 817, 819 to rotate one or both of them and drive grating unit 822. In exemplary embodiments, a motor 818 is located on the back of the gear holder 812 toward the top left corner and is operably connected to the drive gear 819. At least one laser light source 814 is provided and positioned so the light path 815 it transmits projects through the grating unit 822. The grating unit 822 and grating unit holder 820 are configured and located so the grating unit 822 is generally in the path of light projected by the laser light source 814. The design of this projection light assembly 810 advantageously facilitates easy manual replacement and updating of the grating unit 822.

In operation, the projection lighting assembly 810 functions by providing circular motion of its key components. The grating unit 822 moves circumferentially according to a fixed radius and, in exemplary embodiments, translates without rotation. More particularly, motor 818 drives drive gear 819, which turns itself and the passive gear 817 to rotate grating unit holder 820. The grating unit holder 820, in turn, moves grating unit 822 circumferentially in a fixed radius. In exemplary embodiments, there are a plurality of frames 828 configured in a circular arrangement on the grating unit 822. Each frame 828 may contain a different animation pattern representing a different action or change in theme.

In exemplary embodiments, patterns on the grating unit 822 are level arranged in circles such that each frame 828 is arranged horizontally with respect to the center of the circle. In other words, the grating frames 828 are placed in the horizontal direction and array along the center of the circle in turn, i.e., the angle of each pattern or frame 828 to the horizontal line is vertical and the same. Thus, in operation, when the motor 818 drives the gears 817, 819, the grating unit holder 820, and ultimately the grating unit 822, the light path 815 projects through each frame 828 of the rotating grating unit 822 in sequence to create an animation effect. The structure of exemplary gear-driven projection light assemblies advantageously prevents the projection pattern from tilting, deforming, or distorting.

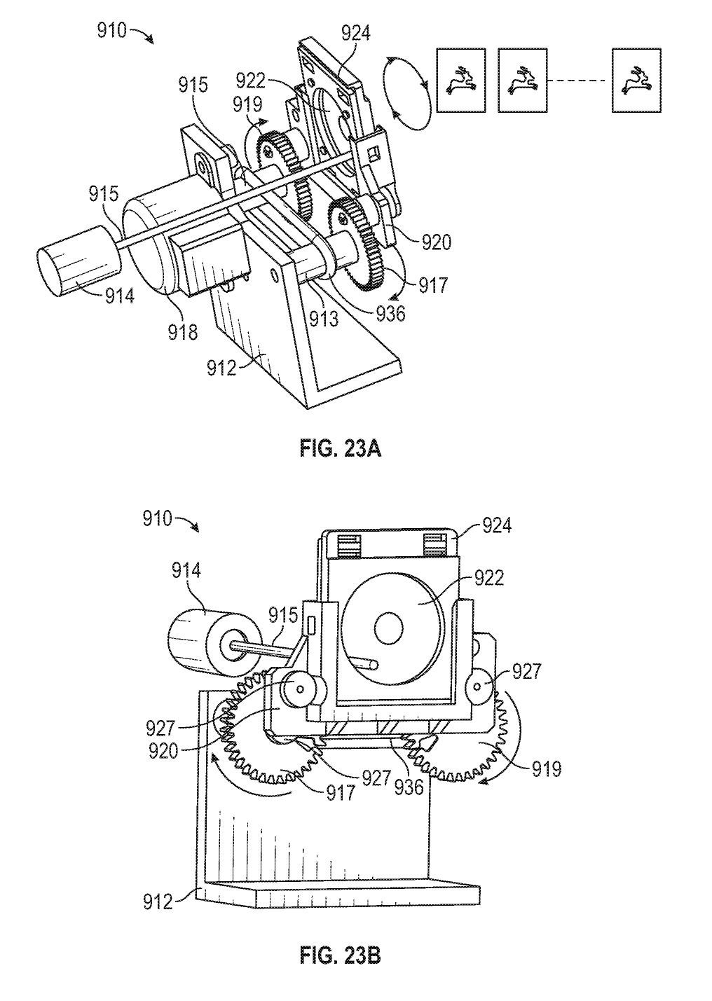

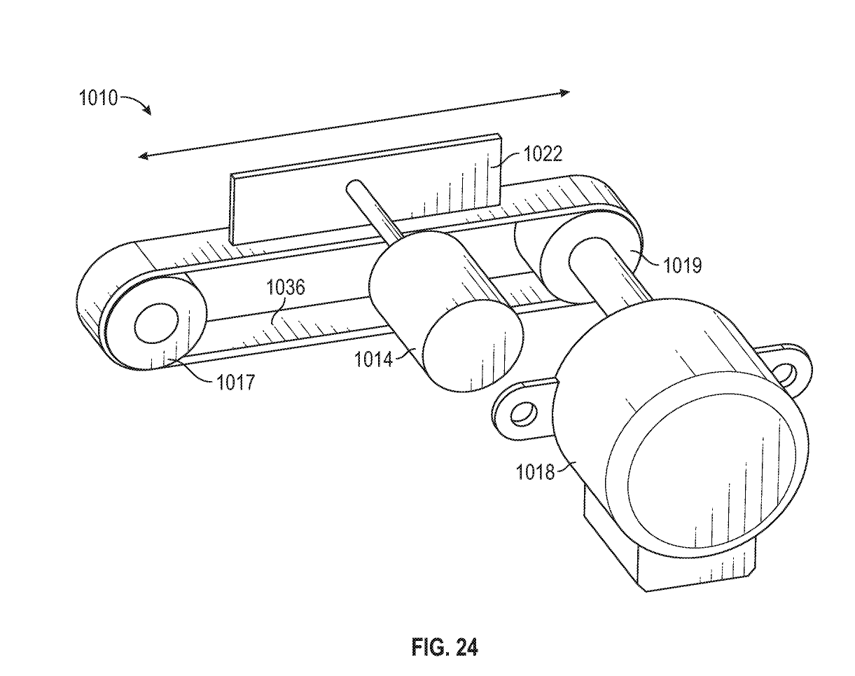

Turning now to FIGS. 23A-23B, a projection light assembly utilizing a transmission belt will be described. Exemplary embodiments of a projection light assembly 910 rely on a transmission belt 936 to drive the grating unit 922. Projection lighting assembly 910 comprises a gear holder 912 which mounts first and second wheels 917, 919. In exemplary embodiments, the first wheel 917 is a passive wheel while the second wheel 919 is a drive wheel. A grating unit holder 920 is connected to one or both of the first wheel 917 and second wheel 919 and operably links the wheels. Pins 927 may be used to attach the grating unit holder 920 to the wheels 917, 919. In exemplary embodiments, a grating unit 922 is disposed in the grating unit holder 920. A buckle 924 may be provided to secure the grating unit 922 to the grating unit holder 920.

A transmission belt 936 is operably connected to the wheels 917, 919. More particularly, each wheel 917, 919 is mounted to the gear holder 912 by a respective axle 913, 915, and the transmission belt 936 wraps around both axles 913, 915. One or more motors 918 may be provided and attached to the gear holder 912 and operably connected to one or both of the wheels 917, 919 via one or both axles 913, 915. In this configuration, the motor can rotate one or both of the axles 913, 915 and the wheels to drive grating unit 922. In exemplary embodiments, a motor 918 is located on the back of the gear holder 912 toward the top left corner and is operably connected only to the drive wheel 919. At least one laser light source 914 is provided and positioned so the light path 915 it transmits projects through the grating unit 922. The grating unit 922 and grating unit holder 920 are configured and located so the grating unit 922 is generally in the path of light projected by the laser light source 914. The design of this projection light assembly 910 advantageously facilitates easy manual replacement and updating of the grating unit 922.

In operation, the grating unit 922 moves circumferentially according to a fixed radius and, in exemplary embodiments, translates without rotation. The motor 918 drives axle 915 and moves transmission belt 936. The drive wheel 919 turns itself and passive wheel 917, thereby rotating grating unit holder 920. The grating unit holder 920, in turn, moves grating unit 922 circumferentially in a fixed radius. In exemplary embodiments, there are a plurality of frames 928 configured in a circular arrangement on the grating unit 922, with each frame 928 containing a different animation pattern representing a different action or a change in theme. In exemplary embodiments, patterns on the grating unit 922 are level arranged in circles such that each frame 828 is arranged horizontally with respect to the center of the circle. When the motor 918 drives the transmission belt 936 and drive wheels, the grating unit holder 920, and ultimately the grating unit 922, the light path 915 projects through each frame 928 of the rotating grating unit 922 in sequence to create an animation effect.

As shown in FIG. 24, an exemplary embodiment is designed so the grating unit moves in a straight line instead of circumferentially. Projection light assembly 1010 has two wheels 1017, 1019. A transmission belt 1036 wraps around the wheels 1017, 1019, and a motor is coupled to wheel 1019, which is the drive wheel. A grating unit 1022 is coupled to the transmission belt 1036. At least one laser light source 1014 is provided and positioned so the light path 1015 it transmits projects through the grating unit 1022. In operation, the motor 1018 drives drive wheel 1019, which turns and turns passive wheel 1017, thereby turning the transmission belt 1036 and moving the grating unit 1022 horizontally across the light path 1015 of the laser light source 1014.

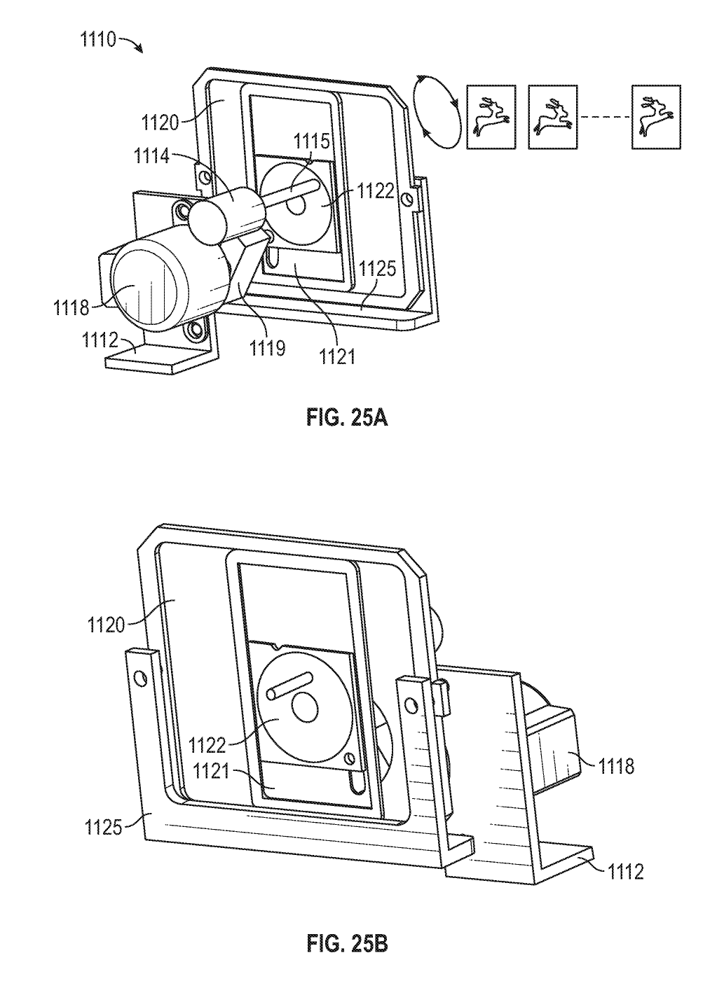

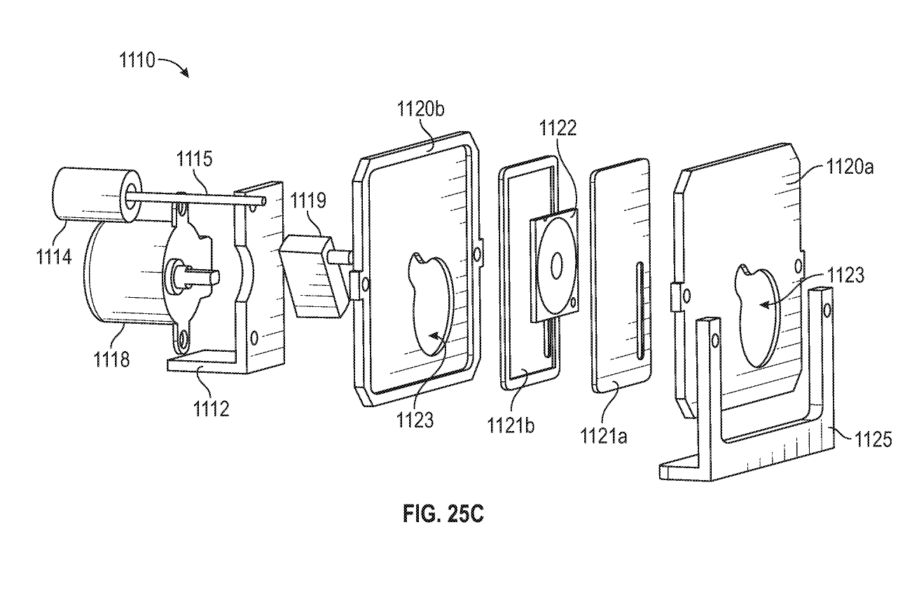

Referring now to FIGS. 25A-25C, exemplary embodiments of a projection light assembly employing an eccentric wheel will now be described. In these embodiments, the grating unit is limited to a two-dimensional plane and driven by a mot with an eccentric wheel to move in translation. Projection light assembly 1110 has a motor holder or base 1112 to mount motor 1118. A slider board 1120 is coupled to the motor 1118, and a laser slider 1121 disposed in the slider board 1120. As best seen in FIG. 25C, in exemplary embodiments slider board 1120 has two boards 1120a, 1120b that house laser slider 1121 when the boards 1120a, 1120b are fastened to each other. Each board 1120a, 1120b may define a substantially circular gap 1123 in which a grating unit 1122 can be disposed. Also shown in FIG. 25C, in exemplary embodiments laser slider 1121 is a two-piece component having a first and second slider 1121a, 1121b that house a grating unit 1122 inside it when the first and second sliders 1121a, 1121b are connected. In exemplary embodiments, a fixing frame 1125 is provided to mount the slider board 1120.

One or more motors 1118 may be mounted on a motor holder 1112 and operably connected to a motor bushing or eccentric wheel 1119 to rotate the grating unit 1122. In exemplary embodiments, the eccentric wheel 1119 is directly connected to the grating unit 1122. At least one laser light source 1114 is provided and positioned so the light path 1115 it transmits projects through the grating unit 1122. The grating unit 1122 and slider board 1120 are configured and located so the grating unit 1122 is generally in the path of light projected by the laser light source 1114. The design of this projection light assembly 1110 advantageously facilitates easy manual replacement and updating of the grating unit 1122.

In operation, the grating unit 1122 moves circumferentially according to a fixed radius. The motor 1118 drives eccentric wheel 1110, which acts as a crankshaft to rotate the grating unit 1122. The grating unit 1122 is generally limited to a two-dimensional plane and moves in translation. In exemplary embodiments, there are a plurality of frames 1128 configured in a circular arrangement on the grating unit 1122, with each frame 1128 containing a different animation pattern representing a different action or change in theme.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

Thus, it is seen that improved projection light assembly, systems, and methods are provided. It should be understood that any of the foregoing configurations and specialized components or chemical compounds may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

1. A projection light assembly comprising:
a gear holder;
a first gear and a second gear operably linked by the gear holder;
a motor coupled to one or both of the first gear and second gear;
a grating unit holder movably connected to one or both of the first gear and the second gear;
a grating unit disposed in the grating unit holder, the grating unit being driven by the motor and moved by the first gear and the second gear such that the grating unit moves circumferentially in a fixed radius;
at least one laser light source positioned such that light generated by the laser light source and transmitted in a light path projects through the grating unit.

2. The projection light assembly of claim 1 wherein the first gear and the second gear have substantially the same diameter.

3. The projection light assembly of claim 1 wherein when the grating unit is moved, the light path projected through the grating unit creates an animation effect.

4. The projection light assembly of claim 1 wherein the grating unit contains multiple frames arranged in a circle.

5. The projection light assembly of claim 4 wherein each frame contains a different animation pattern representing a different action or change in theme.

6. The projection light assembly of claim 4 wherein each frame is arranged horizontally with respect to the center of the circle.

7. The projection light assembly of claim 1 wherein the first gear is a passive gear and the second gear is a drive gear.

8. The projection light assembly of claim 7 further comprising a third gear operably connected to the first and second gear, the third gear being a transmission gear.

9. The projection light assembly of claim 1 wherein the grating unit is manually replaceable.

10. A projection light assembly comprising:
a first wheel and a second wheel;
a transmission belt coupled to the first wheel and the second wheel;
a motor coupled to one of the first wheel and the second wheel;
a grating unit coupled to the transmission belt, the grating unit being driven by the motor and moved by the transmission belt;
at least one laser light source positioned such that light generated by the laser light source and transmitted in a light path projects through the grating unit.

11. The projection light assembly of claim 10 further comprising:
a gear holder; and
a grating unit holder movably connected to one or both of the first wheel and second wheel;
wherein the grating unit is coupled to the transmission belt via the grating unit holder and one or both of the first wheel and second wheel; and
wherein the grating unit moves circumferentially in a fixed radius.

12. The projection light assembly of claim 10 wherein the grating unit moves in a straight line.

13. The projection light assembly of claim 10 wherein when the grating unit is moved, the light path projected through the grating unit creates an animation effect.

14. The projection light assembly of claim 11 wherein the grating unit contains multiple frames arranged in a circle.

15. A projection light assembly comprising:
a slider board;
a motor coupled to the slider board;
an eccentric wheel coupled to the motor;
a laser slider disposed in the slider board;
a grating unit disposed in the laser slider, the grating unit being driven by the motor and moved by the eccentric wheel;
at least one laser light source positioned such that light generated by the laser light source and transmitted in a light path projects through the grating unit.

16. The projection light assembly of claim 15 wherein the grating unit is in a two-dimensional plane.

17. The projection light assembly of claim 15 wherein when the grating unit is moved, the light path projected through the grating unit creates an animation effect.

18. The projection light assembly of claim 15 wherein the grating unit contains multiple frames arranged in a circle.
